(19) United States
(12) Patent Application Publication
(10) Pub. No.: US 2019/0104285 A1
(43) Pub. Date: Apr. 4, 2019

(54) AUTOMOTIVE ANIMATED IMAGE PROJECTOR AND METHOD OF OPERATION

(71) Applicant: Pacific Insight Electronics Corp., Nelson (CA)

(72) Inventors: Michael MEDVEC, Saline, MI (US); Lorenzo F. MANDERVILLE, Grand Blanc, MI (US); Robert H. MILLER, Canton, MI (US); Erik Lee MEASEL, Waterford Twp., MI (US)

(21) Appl. No.: 16/150,040

(22) Filed: Oct. 2, 2018

Related U.S. Application Data
(60) Provisional application No. 62/567,082, filed on Oct. 2, 2017.

(51) Int. Cl. H04N 9/31

(52) U.S. Cl. CPC H04N 9/3102; H04N 9/3141

(57) ABSTRACT

An automotive animated image projector comprises a light source emitting a light beam, a microelectromechanical system projector aligned to receive the light beam and project an animated image onto a target surface, a computer system programmed to control the light source and the microelectromechanical system with commands to produce the animated image, and a transmission link for sending the commands from the computer system to the light source and the microelectromechanical system projector. In some embodiments, the target surface is the ground next to a vehicle and the animated image illuminates the ground to assist entry into, and exit from, the vehicle. A method is also provided of projecting an animated image from an automotive animated image projector. The method comprises generating a light beam, directing the light beam onto a microelectromechanical system projector, manipulating the light beam by dynamically controlling the microelectromechanical system projector to generate animated images that are projected onto a target surface.

### CROSS-REFERENCE TO RELATED APPLICATIONS

This application claims priority to U.S. Provisional Patent Application Nos. 62/567,082 filed on Oct. 2, 2017 the content of which is herein incorporated by reference in its entirety.

### BACKGROUND OF THE INVENTION

### Field of the Invention

The present application relates to an automotive animated image projector and a method of operating same. More particularly, the automotive animated image projector is mounted to a vehicle and projects an animated image on the ground next to the vehicle or onto the vehicle itself or onto an interior surface of the vehicle.

### Description of Related Art

The automotive industry often blends functional features with aesthetic features to distinguish products from competitors and to make their products more desirable. One area where advancements have been made in recent years is lighting. This is because new lighting technologies offer more capabilities in what the lighting can do, how it looks, and where it can be installed.

Recently, manufacturers have been making advancements in external lighting, such as, so-called “puddle lamps” that illuminate the ground around the vehicle. This is particularly useful near the doors, to assists the driver and passengers to enter and exit the vehicle, while avoiding puddles and other obstacles. While the general concept of puddle lamps is not new, recent developments have added images that can be used to promote vehicle brands, for example by generating an image of a manufacturer's logo within the light.

U.S. Pat. No. 6,685,347, entitled, “Gobo Projector for a Vehicle” discloses combining a puddle lamp with a gobo, which is a translucent image printed onto a slide, to project a static image onto the ground.

U.S. Patent Application Publication No. US 2010-0321945 A1, entitled “Vehicular Graphics Projection System” is another example of a puddle lamp that projects a static image onto the ground near the vehicle, with the image generated by a gobo, described as an “optical component” such as a laser-etched lens.

U.S. Pat. No. 9,321,395, entitled, “Vehicle Puddle Lamp Assembly Generating Animated Image and Method”, U.S. Patent Application Publication No. US 2017-0050558 A1, entitled, “Vehicle Puddle Lamp Assembly Generating Moving Image and Method”, and U.S. Patent Application Publication No. US 2016-0193959 A1, entitled, “Vehicle Lamp Assembly Generating Animated Image and Method” disclose using a plurality of light projectors located on a vehicle to illuminate different lighted image patterns on a ground surface adjacent to the vehicle. The image filters depicted and described in these disclosures are like the gobo taught by the '347 patent noted above. That is, different image patterns are predetermined fixed images that can be projected in a sequential order to generate within the light, or by the light itself, the appearance of an animated image. However, because different projectors are needed for each individual image, it is only practical for simple animations that are limited to the images provided on the gobo or other gobo-like optical component.

To attempt a more complex animation with this method, unless a large number of projectors are employed, the animations have jerky movements. With an apparatus that uses a gobo-like optical component, animations are limited to a fixed number of images and one for each projector unless multiple optical components are provided for each projector. However, if more than one optical component is used for each projector, this necessitates a mechanism for switching optical components, which adds to the complexity and size of such an apparatus. This makes gobo projectors impractical for projecting complex animations and video.

The size of the apparatus can also be a concern for automotive applications where there are limited locations for mounting the apparatus where it can project light around the vehicle access points. For example, to illuminate the ground near a vehicle's doors the side mirrors are a convenient place for mounting a puddle lamp. However, the sizes of side mirror housings are normally kept as small as possible to reduce wind resistance, wind noise, and the overall width of the vehicle. To install a puddle lamp in the side mirror housing it is desirable for the puddle lamp apparatus to be compact in size, which is problematic for an apparatus that uses a plurality of projectors.

An alternative location for mounting puddle lamps is on the chassis below the vehicle body, but a drawback of locations closer to the ground is that the apparatus can be exposed to a harsher environment where it might be more likely to be covered in dirt and/or hit by rocks or knocked by obstacles on the road. While there may be more room to mount a puddle lamp in this location, being closer to the ground, the light must be spread wide to cover the same area that would be lit by a light that is mounted further from the ground and the housing would need to be made more rugged to prevent damage.

Accordingly, an apparatus and method of improving animated images within lighting, to make motion smoother and more versatile would be an improvement over the animations currently achievable with the above-described technology for puddle lamps. It would also be an improvement if such an apparatus could be made in a more compact size than a puddle lamp apparatus that uses a plurality of projectors so that designers can have more flexibility when choosing a mounting location.

### BRIEF SUMMARY OF THE INVENTION

An automotive animated image projector is provided comprising, a light source emitting a light beam, a microelectromechanical system (MEMS) projector aligned to receive the light beam and project an animated image onto a target surface, a computer system programmed to control the light source and the microelectromechanical system with commands to produce the animated image, and a transmission link for sending the commands from the computer system to the light source and the microelectromechanical system projector.

In one aspect of the disclosure, when brighter and higher resolution images are needed the light source is a laser, and more preferably a laser diode. To project color images the laser comprises a plurality of color component lasers, for example red/green/blue (RGB) laser diodes. In alternative embodiments, other types of light sources can be used instead of a laser. By way of example, the light source can be a light emitting diode (“LED”) or a plurality of LEDs.

In disclosed features, the microelectromechanical system projector can comprise a 2-dimensional laser scanning device, or a scanned 1-dimensional array, or a digital micro-mirror device. In one aspect of the disclosure, the microelectromechanical system projector includes a 2-dimensional laser scanning device, it can comprise a scanning mirror connected to flexures associated with two different axes and a mechanism for rotating the scanning mirror around the two different axes. When the light source is an LED instead of a laser the light generated from the LED is preferably collimated before being directed onto the scanning mirror, for example, by being processed by an optical lens system.

To generate the projected image, or series of images in the case of an animation, the light projected from the microelectromechanical system projector can, in one example, be projected in a raster pattern. The computer system can include a microelectromechanical system application-specific integrated circuit (“ASIC”) that is programed to control the microelectromechanical system projector. The computer system can further include a video ASIC programed to control the light source and to give commands to the microelectromechanical system ASIC. The computer system can also include a memory device for storing image data. Alternatively, or in addition, the computer system can receive image data from an external source.

In another disclosed feature discussed herein, the microelectromechanical system projector can include a liquid crystal on silicon (LCoS) LCD pixel array. A LCoS LCD pixel array operates as a microelectromechanical system by employing an imaging device that utilizes long chain polar molecules that rotate and/or change orientation when exposed to electrical fields. The LCoS can have a transmissive LCD pixel array or a reflective LCD pixel array.

In another disclosed feature of the automotive animated image projector discussed herein, at least the microelectromechanical system projector and the computer system are disposed inside a housing that has external dimensions that define a volume less than 85 cubic centimeters, and more preferably less than 60 cubic centimeters. Smaller sizes allow more flexibility and choices in where it can be mounted. However smaller housing sizes introduce more challenges with heat dissipation. Microelectromechanical systems projectors normally have a specified operating temperature range, so with a smaller housing it can be more difficult to keep within the specified range without resorting to the extra complexity and sometimes impracticality of using cooling means, such as a cooling fan.

In some embodiments the light source can be located inside the housing. In other embodiments, to reduce heat build-up inside the housing, the light source can be located in a separate housing, outside the housing that houses the microelectromechanical system projector, for example, by transmitting the light into the housing via, for example, a total internal reflection (“TIR”) light pipe or fiber optic cable(s). Since ordinary plastics typically have a thermal conductivity of 0.2 W/(m·K), which is much lower than that of most metal, when heat dissipation is important plastic is not usually chosen for the housing material. However, plastic housings can be a lower cost alternative to metals, and it has been found that for the components of the disclosed automotive animated image projector, plastics with a thermal conductivity of 0.5 W/(m·K) or more preferably between 5 to 15 W/(m·K) can be employed as the material for the housings.

For an automotive animated image projector, it is also desirable for the housing to be sealed. If the automotive animated image projector is used to project images outside a vehicle it can be exposed to the weather, which includes rain, bugs, dirt and other contaminants. If installed inside a vehicle it can also be exposed to spills and other contaminants. In some embodiments, part of the sealing can be provided by low pressure overmolding.

In one aspect, the target surface is an area on the ground next to a vehicle. In some embodiments, a convenient location for installing the microelectromechanical system projector and the light source is inside a side mirror housing of the vehicle. In another aspect the projector can be installed inside a vehicle and the target surface is inside the vehicle. In yet another aspect, the projector can be installed on a vehicle and the target surface is an exterior surface of the vehicle.

Methods are also provided for projecting an animated image from an automotive animated image projector. In some aspects of the disclosure, the methods include generating a light beam, directing the light beam onto a microelectromechanical system projector, manipulating the light beam by dynamically controlling the microelectromechanical system projector to generate animated images that are projected onto a target surface. In one aspect of the disclosure, the microelectromechanical system projector can include a MEMS micro-mirror and the method includes dynamically controlling the orientation of the MEMS micro-mirror to illuminate individual pixels in the animated images. In one aspect of the disclosure, the microelectromechanical system projector includes an LCoS LCD pixel array and the method includes dynamically controlling electrical fields applied to the LCoS LCD pixel display to generate the animated images.

In another aspect of the disclosure, the light beam is generated from an RGB light source or other light source that blends light from different colored lights, and the method further includes controlling the light source to control the color of the light beam. In another aspect of the disclosure, the light source generates a light beam from an LED light source, and the method further includes collimating the light to focus and project parallel light beams onto a pixel array associated with the microelectromechanical system projector.

Disclosed methods include projecting still images and/or animated images. In another aspect of the disclosure the methods include projecting images using a raster pattern.

In one aspect of the disclosure, the target surface is a ground area next to a vehicle, and the methods further include using the animated image to illuminate the ground area. In another aspect, the target surface is an interior surface of a vehicle, and the methods further include using the animated image to illuminate the interior surface. In yet another aspect, the target surface is an external surface of a vehicle.

In another aspect of the disclosure, the methods include selecting the animated image from a plurality of available images, based upon a vehicle condition. For example, some of the vehicle conditions can be an unlocked door, the activation of the hazard lights, the opening of a hatch or trunk, or the triggering of an alarm system. For vehicles equipped with a panic button, the projected image can be a flashing signal, such as flashing the word “HELP” or “CALL 911” in combination with flashing other vehicle lights.

### BRIEF DESCRIPTION OF THE DRAWINGS

FIG. 1 is a schematic of an automotive animated image projector in accordance with disclosed embodiments.

FIG. 2 is a schematic of an automotive animated image projector that has an RGB light source in accordance with disclosed embodiments.

FIG. 3 is a perspective view of a vehicle with an automotive animated image projector mounted in a side mirror with an image projected onto the ground next the vehicle in accordance with disclosed embodiments.

FIG. 4 is a top view of the vehicle of FIG. 3, showing how light from the automotive animated image projector is projected onto the ground in accordance with disclosed embodiments.

FIG. 5 is a perspective view of a center console for a vehicle that has an automotive animated image projector that projects an image onto an interior surface of the vehicle in accordance with disclosed embodiments.

FIG. 6 is a perspective view of the interior of a bus, showing an automotive animated image projector that projects an image onto an interior surface of the vehicle in accordance with disclosed embodiments.

FIG. 7 shows a perspective view of a bus with an automotive animated image projector that projects an image onto an exterior surface of the vehicle in accordance with disclosed embodiments.

FIG. 8 is a side view that shows a commercial truck equipped with an automotive animated image projector that projects an image onto an exterior surface of the vehicle in accordance with disclosed embodiments.

FIG. 9 is a schematic of an embodiment of the automotive animated image projector in accordance with disclosed embodiments.

### DETAILED DESCRIPTION OF ILLUSTRATIVE EMBODIMENTS

Reference is now made in detail to the present preferred embodiments, examples of which are illustrated in the accompanying drawings. Whenever possible, the same reference numerals are used throughout the drawings to refer to the same parts, and if the parts are the same and indicated by the same reference numeral, for brevity such parts may not be re-introduced and described with respect to each drawing. If the parts are not the same, but similar in function, like reference numerals are used.

The following detailed description represents embodiments that are intended to provide an overview or framework for understanding the nature and character of the claims. The accompanying drawings are included to provide further understanding of the claims and constitute part of the specification. Accordingly, the detailed descriptions and drawings are non-limiting to the scope of what is claimed and are intended to illustrate and explain the principles and operations of these embodiments, as claimed.

An automotive animated image projector can serve to illuminate target surfaces with an animated image. The target surface can be the ground next to the vehicle. If the target surface is the ground next to a vehicle door, the animated image can illuminate the ground to assist with entry into, and exit from, the vehicle. If the target surface is the ground next to a storage compartment of the vehicle, for example the ground at the rear of the vehicle next to a trunk or cargo area, the light from the animated image can help with loading and unloading of the vehicle. If the target surface is the ground next to a wheel, the light from the animated projected image can help to provide light for changing a wheel. The target surface could also be inside the vehicle, for example the cargo area, or the ceiling. In still other embodiments, the target surface could be an exterior surface. For example, the animated image can be used for advertising on the side of a bus or for displaying menu items on the side of a food truck.

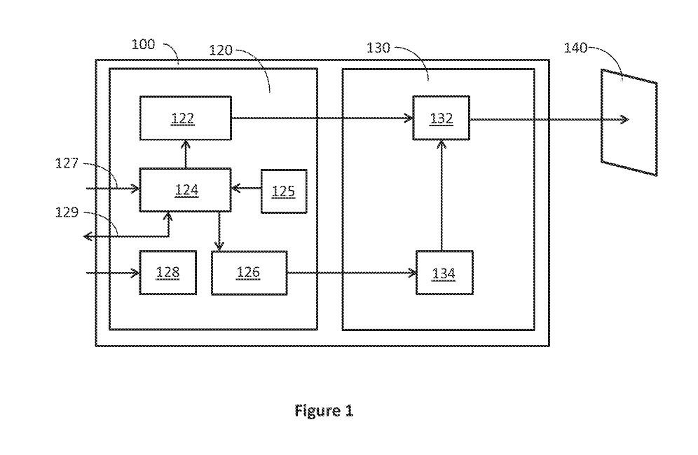

With reference to FIG. 1, automotive animated image projector 100 comprises computer system 120 and integrated photonics module 130. In one example, integrated photonics module 130 comprises light source 134, which emits a light beam, microelectromechanical system projector 132, which is aligned to receive the light beam and reflect the light beam to project and illuminate a pixel in image 140, which is displayed on a target surface. Computer system 120 is programmed to control light source 134 and microelectromechanical system 132 with commands to sequentially generate a plurality of light beams, each assigned to a different pixel in image 140 at a refresh rate frequency high enough to produce image 140. Since the light beams are projected at such a high refresh rate frequency, the human eye processes all of the pixels together to see image 140.

By keeping the projected light for each pixel the same each cycle a still image can be projected by automotive animated image projector 100, and, by changing at least some of the pixels from cycle to cycle, the image can appear to be animated to the human eye. A refresh rate frequency as low as 30 hertz can be used. Present day video standards presently employ a minimum refresh rate frequency of 60 hertz. Higher frequencies are also in use, for producing smoother motion in more dynamic animations. Some video projectors currently use a refresh rate frequency of 240 hertz, and while this and higher frequencies are possible, the human eye typically cannot perceive improvements in the quality of animations with refresh rate frequencies higher than 120 hertz. Since refresh rate frequencies below 30 hertz result in noticeable flicker in animated images and refresh rate frequencies between 5 and 30 hertz have been known to produce seizures in some people, in preferred embodiments, a refresh rate frequency between 30 hertz and 240 hertz can be used, and more preferably a refresh rate frequency between 60 hertz and 120 hertz.

Images projected in this way can be projected in any pattern, but a raster pattern is one of the standards used in video projection. That is, in the projection of animated images, the sequence in which pixels are illuminated need not be limited to a particular pattern as long as the pixels in an image are projected with sufficient refresh rate frequency so that the projected pixels appear as a single projected image. For example, if an image only illuminates a portion of the target surface area, computer system 120 can be programmed so that it skips pixels in the raster pattern so that microelectromechanical system projector 100 is only manipulated to send light to areas of the target surface to be illuminated as part of projected image 140.

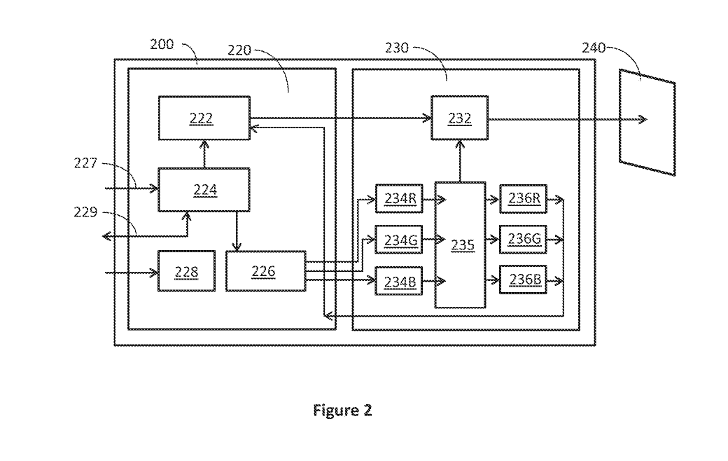

Known techniques for sending the commands from computer system 120 to light source 134 and the microelectromechanical system 132 can be employed, by way of example, transmission links such as wires, fiber optics or wireless transmitters and receivers. In FIGS. 1 and 2, the lines with arrows between elements indicate transmission links that serve as communication paths with the arrows indicating the direction of the commands or data transfer. In the illustrated embodiment shown in FIG. 1, computer system 120 comprises ASICs. First ASIC 122 is an integrated circuit for controlling microelectromechanical system 132. First ASIC 122 receives commands from second ASIC 124, which is a circuit for processing video data received from an associated memory storage device 125 (optional) that could be integrated with computer system 120. In a preferred embodiment, flash memory with serial connectivity is employed because compared to other types of memory, this type of memory is relatively inexpensive and is available in sizes that reduce the area needed on the printed circuit board (“PCB”). However, other media storage devices and memory can also be used. It is particularly advantageous to combine memory storage device 125 with computer system 120 and second ASIC 124 can be used to process and de-compress the images when media compression is employed. Alternatively, the video data can be sent to the second ASIC 124 from an external source (not shown), as indicated by communication line 127, which can represent data transmissions by wire, fiber optics, or wireless signal. That is, communication line 127 is a transmission link that can be employed to stream video data from an external source. For example, a high bandwidth connection whether wired or wireless with sufficient throughput for transmitting the desired image(s). For example, if wired, a Fast Ethernet such as 100BASE-T1 or 1000BASE-X/T using a MOST™ Bus (Media Oriented Systems Transport) are examples of high-speed multi-media network technology specifications that are used in the automotive industry and that could be used for this application. If wireless, media can be streamed by Wi-Fi or Bluetooth®. Second ASIC 124 also controls light source driver 126, which in turn controls light source 134. When light source 134 is a laser diode, light source driver 126 is a laser driver. In preferred embodiments, power is delivered to automotive animated image projector 100 through power management integrated circuit 128 as indicated by the incoming arrow.

Computer system 120 can be controlled through communication line 129 to activate automotive animated image projector 100 upon detection of certain predetermined vehicle conditions. Communication line 129 can be any one of the wired or wireless methods discussed above or, for example, through the use of a logic relay. Second ASIC 124 can be programmed to select specific images and retrieve them via communication line 127 based upon the detected vehicle condition.

In a preferred embodiment, light source 134 is a laser, such as a laser diode. FIG. 1 shows an embodiment that can project a monochrome image. For monochrome images, a single laser diode can be employed. Lasers have the advantage of not needing a focusing lens because there is virtually no dispersion of the light beams projected from microelectromechanical system 132. While some of these preferred embodiments are described using laser light sources, the light source need not be a laser so long as the light source is powerful enough for projecting enough light for illuminating the images on the target surface. For example, high output LEDs can also be used as the light source for some applications as long as the light from the LED light source is collimated into a concentrated beam.

FIG. 2 shows another embodiment of an automotive animated image projector 200 that can project color images. Integrated photonics module 230 employs an RGB laser diode. An RGB laser diode is so named because it combines light from a red light source, a green light source, and a blue light source, shown in FIG. 2 as red laser diode 234R, green laser diode 234G and blue laser diode 234B. Computer system 220 comprises first ASIC 222, second ASIC 224, laser driver 226 and power management integrated circuit 228, which function in similar ways to the like-named components described in relation to FIG. 1. Differences between the embodiments described with FIG. 2 and FIG. 1 include the laser driver 226 (FIG. 2) controls the light intensity from three different laser diodes 234R, 234G and 234B, so that beam combiner 235 can generate a whole spectrum of colors to produce color images. In preferred embodiments, the selected color for an individual pixel in projected image 240 is directed from beam combiner 235 to microelectromechanical system 232, which is controlled to deflect the colored light beam to a predetermined pixel location on projected image 240. As shown in FIG. 2, integrated photonics module 230 can further comprise photodiodes 236R, 236G and 236B, each being associated with a respective one of light sources 234R, 234G, 234B. Photodiodes 236R, 236G, and 236B measure light intensity from the respective light sources 234R, 234G, 234B and give feedback to first ASIC 222. ASIC 222 receives the feedback from photodiodes 236R, 236G, and 236B and uses it to make adjustments to more accurately control the power of the light sources 234R, 234G, 234B. When making adjustments ASIC 222 adjusts the command signals sent to laser driver 226 via second ASIC 224 to automatically recalibrate laser diodes 234R, 234G and 234B for, for example, color correctness our output intensity.

In preferred embodiments, microelectromechanical system projector 132, 232 typically comprises a mirrored surface, also known as a MEMS micro-mirror, that reflects the light beam to a pixel location on the target surface. The computer commands to light source 134, (or 234R, 234G, and 234B) dictate the light intensity and/or color for each pixel. Some of the microelectromechanical system projectors that can be used by the automotive animated image projector include a 2-dimensional laser scanning device, a scanned 1-dimensional array, and a digital micro-mirror device. If the microelectromechanical system projector is a 2-dimensional laser scanning device, which can include, for example, a scanning mirror connected to flexures associated with two different axes and mechanisms for manipulating the orientation of the mirror in the directions permitted by the flexures. The MEMS micro-mirror can be one of a plurality of micro-mirrors arranged in a pixel array. When there is a pixel array, light source 134 can be a white light source processed by an optical lens system to project parallel white light into a beam splitter. The beam splitter can be oriented to output this light towards the pixel array at a 90-degree angle to the incoming light path. The output light illuminates the pixel array, which modulates the intensity and color of the light reflecting from it. Light leaving the pixel array bearing the image passes through the beam splitter without its course being affected. This light is then processed by a second optical lens system, which is designed to deliver the image at the desired size onto a target surface.

In another preferred embodiment, microelectromechanical system projector 132 can include an LCoS for the surface that receives the light beam from light source 134. Electrical fields are applied to the LCoS to change how light directed to each pixel in an LCD pixel array is absorbed or un-absorbed to generate an image that is projected onto a target surface. The LCoS can be reflective LCD pixel array, which modulates the light reflected from it in both intensity and color. A reflective LCD pixel array can output light at an angle, for example a 90-degree angle, from the light beam that it receives, so in this way it can be positioned like the embodiment that employs a MEMS micro-mirror. A LCoS projector is within the meaning of a microelectromechanical system projector as defined in this specification and in the context of the subject apparatus because it is a miniaturized component that uses electric fields to cause a mechanical change by manipulating long chain polar molecules to rotate and or change orientation in ways that effect light absorption or non-absorption. By associating “tri-stimulus” red, green and blue color filters with a liquid crystal imaging device, color images can be rendered. An advantage of an LCoS LCD pixel array is that it can use LED-based white light sources instead of a laser diode, and this can reduce the overall cost of the apparatus. With one embodiment of a LCoS that uses a reflective LCD pixel array, the light beam from light source 134 is processed by an optical lens system that directs parallel white light into a beam splitter. The beam splitter is oriented to output this light at a 90-degree angle to the light beam that was directed at the pixel array. The light reflected from the pixel array can be directed through a second optical lens system that delivers the image at a desired size onto the target surface. A disadvantage of a lower cost LED/LCoS combination as compared to a laser/MEMS micro-mirror combination is that the resulting image may have a lower resolution, or it may not be as bright, but, surprisingly, the brightness and resolution can be suitable for certain applications, such as automotive puddle lamps. When the image generated from a LED/LCoS combination with a resolution of 320×240 at 30 frame per second rate is projected on a screen or smooth surface where one might be accustomed to viewing higher resolution images, the image can appear pixelated, and this could deter manufacturers from selecting this combination. However, when the same projector is used to project an image onto a textured road surface in low light conditions, which is when a puddle lamp is needed, surprisingly, the image quality has been found to be more than adequate for such applications. In this application the color light level resolution was 5 bits for red (32 levels between off and full scale), 6 bits for green (64 levels between off and full scale), and 5 bits for blue (32 levels between off and full scale).

In another embodiment, instead of a reflective LCD pixel array, microelectromechanical system projector 132 can comprise a transmissive LCD pixel array to achieve similar results. A transmissive LCD pixel array uses an electronically controllable transparent pixel array. In this embodiment, light source 134 generates a white light source that is processed by an optical lens system to direct parallel white light beams through the pixel array. Like with the reflective LCD pixel array, the transmissive LCD pixel array modulates the light to manipulate intensity and color, except that with a transmissive LCD array the light passes through it instead of being reflected. The light leaving the array can be processed by an optical lens system that is designed to deliver the image onto a target surface at a predetermined distance and with a predetermined image size.

For described embodiments that use a beam splitter with a micro-mirror pixel array or an LCD pixel array, if the parallel white light is directed to the pixel array at an angle, the beam splitter can be eliminated. The image would be reflected from the pixel array at the opposite angle. By way of example, if light source 134 directs a light beam onto the pixel array at an angle of 45 degrees, then the image would be reflected at an opposite angle of negative 45 degrees. The image is foreshortened in the direction of the inclination of the light source, and this can be corrected by optics for pre-distorting or signal processing to compensate for the foreshortening effect associated with this arrangement.

While the embodiments illustrated in FIGS. 1 and 2 show first ASIC 122, 222, which controls respective microelectromechanical system projectors 132, 232, and second ASIC 124, 224, which processes the image data and sends signals to respective first ASIC 122, 222 and to respective laser driver 126, 226, in some embodiments the first and second ASICs can be combined into just one ASIC that performs the same functions.

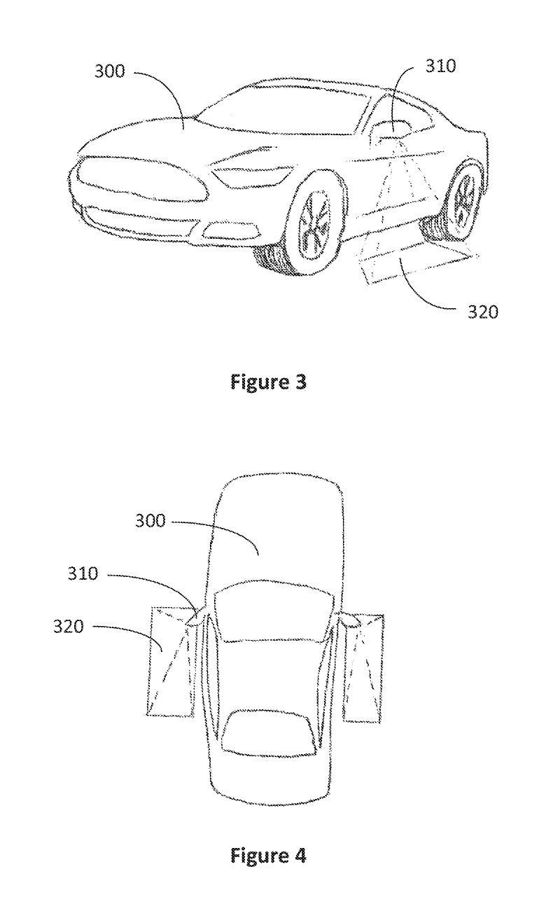

FIG. 3 is a drawing that shows by way of example, vehicle 300 that has an automotive animated image projector installed inside side mirror housing 310. When the automotive animated image projector is activated, an image is projected down to the ground from mirror housing 310. In this illustrated example target surface 320 is next to the door, such that the projected image illuminates the ground so that a person approaching vehicle 300 can see puddles, curbs or uneven ground that might not be seen or noticed without the benefit of the light from the automotive animated image projector. Vehicle manufacturers can use the image to display the manufacturer's logo or an emblem or other image that is associated with a particular vehicle model. In some embodiments, the automotive animated image projector can be designed take advantage of the ability to project animated images. For example, by projecting over a wide target surface area, the animated image can appear to move from one side of the target surface area to an opposite side. That is, by only illuminating some of the pixels that cover the whole target surface, an animated image, such as a horse, could appear to gallop from one side of the target surface area to the other side.

FIG. 4 is a drawing that shows vehicle 300 from FIG. 3, but from a top view, showing side view mirror housings 310 as the location for mounting automotive animated image projectors on both sides of vehicle 300. The dashed lines show the edges of the range for the light beam that projects an animated image onto target surface 320. The illustrated target surface areas are just examples, and other locations can be employed for mounting automotive animated image projectors to illuminate other areas such as target surface near the wheels or next to storage compartments at the front or rear of the vehicle. In another embodiment, the mount for the automotive animated image projectors mounted in the side view mirror housings can be made to allow rotation of the projector so that it can project light to more than one target surface. For example, the mount for the automotive animated image projector can swivel or otherwise rotate to shine light onto a target surface near the front wheels, so that the same projector can be used to selectively shine light for vehicle access or for changing a wheel.

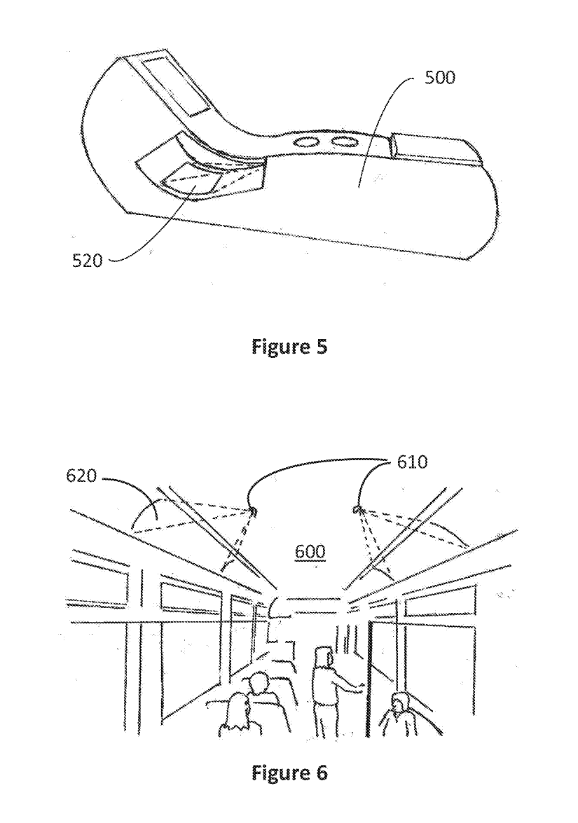

FIG. 5 is a drawing that shows center console 500 that can be installed inside a vehicle between the driver's seat and the front passenger's seat. An automotive animated image projector can be installed inside center console 500 to project an image onto target surface 520. The portion of the console surface above target surface 520 can be optically transparent so that the passengers can see the projected image. The video input for the projected image can include video signals collected from exterior cameras, for example a back-up camera or a series of cameras that can be used to produce an overhead image, also known as a “bird's eye” image or a “360-degree view” that can be used to assist with parking and other driving functions.

FIG. 6 is a drawing that illustrates another vehicle interior application. Bus interior 600 has overhead areas that are often used for advertising or for displaying information about where the bus is, what the next stop is, and how before that stop is reached. Automotive animated image projectors 610 can project images onto target surfaces 620. Projecting images instead of using posters makes it easier to change the advertising. Also, more advertising can be sold because the same target location can be used to display several different advertisements in a time sequence. In addition, by allowing video advertisements, the advertising can be more effective because it can be more attractive and engaging with the passengers. More effective advertising can command higher advertising fees. Bus operators can also project newscasts or other video content that can make travelling on the bus more enjoyable and thereby increase ridership and passenger revenue.

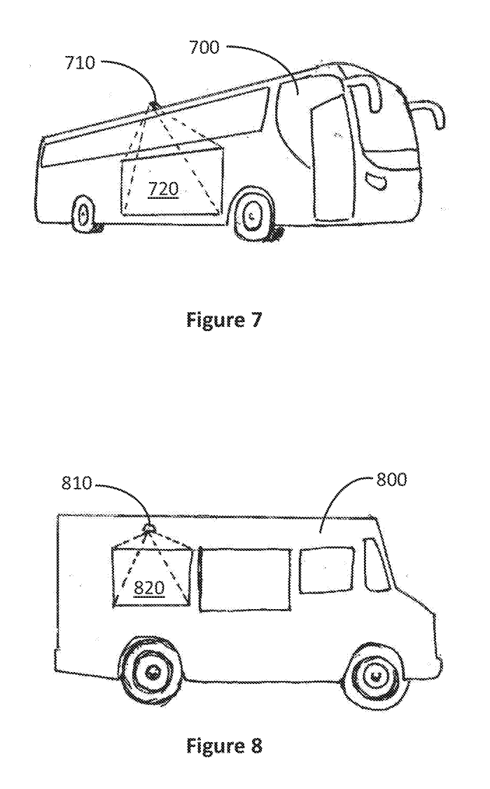

FIG. 7 is a drawing that shows an example of an automotive animated image projector 710 that is employed to project an image onto target surface 720 that is on the side of bus 700. Bus companies often sell advertising space on the outside of buses. These are typically posters that need to be installed and removed every time the advertising space is sold, or when the poster is damaged. An automotive animated image projector has many of the same advantages as the internal application described in relation to FIG. 6. Target surface 720 is just one example of a surface that can be used for advertising. The rear surface is also a large surface that can be used as another target surface for an additional automotive animated image projector. In some embodiments, the windows can also be used as a target surface.

FIG. 8 is drawing that shows truck 800 and another embodiment for employing a target surface that is on an exterior surface of a vehicle. Automotive animated image projector 810 projects an image onto target surface 820. For example, if truck 800 is a food truck, the projected image could be a menu with pictures of the menu items, or an advertisement for the business that encourages people to try the food on offer.

FIGS. 3 through 8 show that an automotive animated image projector can be used for many different applications and those that are illustrated are non-limiting examples. Because different applications could use the same projector but may require different optical lens system for processing the image depending upon variable factors such as the distance between the projector and the target surface, the size of the image and the target surface, and whether any correction is required because of foreshortening effects, if the light is reflected off the microelectromechanical system projector at an angle. Accordingly, in a preferred embodiment of the automotive animated image projector assembly, the same projector assembly can be made to be adaptable for being assembled with different lenses for different focus points using for example, a releasably engagable mount. Also, since the automotive animated image projector can be mounted in locations where it could be exposed to the outside environment, it is important that the projector assembly can be sealed and made waterproof. Techniques for making the projector assembly waterproof include using low pressure overmolding, or resilient seals between components such as those that use silicon or a reaction injection molding polyurethane (“RIM-PU”).

For any product, it is always advantageous to reduce the cost of production, to make the product more appealing to customers and to be more competitive against alternative products. Production costs can be reduced if the same projector assembly can be used for more than one application. To make the same projector assembly suitable for being mounted in different locations as exemplified in the illustrated examples, it is desirable to reduce the overall size of the projector assembly. In preferred embodiments the volume occupied by the projector assembly is less than 85 cubic centimeters, and more preferably less than 60 cubic centimeters.

Making the projector assembly smaller can make it more challenging to manage thermal dissipation to prevent overheating of the microelectromechanical system projector. Some microelectromechanical system projectors have operational parameters that require them to be kept within a specified temperature range. In an automotive application, where the projector assembly can be exposed to extreme heat or extreme cold, the environmental conditions can be more challenging compared to non-automotive applications. In non-automotive applications preventing overheating is accomplished by using a cooling fan, but this solution is not desirable for automotive applications, especially when a sealed housing is needed. Accordingly, it is advantageous to make the housing for the projector assembly thermally conductive to help with heat dissipation. The housing material can be made from thermally conductive metal, or to reduce manufacturing costs, thermally conductive plastic can be substituted with about the same absolute thermal conductivity. In preferred embodiments, when the housing material is made from plastic, the plastic has a thermal conductivity of at least 0.5 W/(m·K) and more preferably at between 5 and 15 W/(m·K) or higher. In addition, if low pressure overmolding is used to seal the projector assembly, it can used to complement the use of thermally conductive plastic for heat dissipation. Another arrangement for assisting with thermal management includes locating the light source in a housing that is separate and spaced remotely from the housing for the microelectromechanical system projector, for example, by directing the light from a remote light source to the projector via a total internal reflection light pipe or fiber optic link.

Disclosed methods include projecting an animated image from an automotive projector mounted on a vehicle onto a target surface. The animated image is created by generating a light beam and directing it onto a microelectromechanical system projector. When the microelectromechanical system projector employs a MEMS micro-mirror, an image is generated by reflecting individual light beams towards a target surface to illuminate individual pixels. Each light beam is reflected to a different target point on the target surface by dynamically controlling the orientation of a mirrored surface in the microelectromechanical system projector. Light beams to illuminate a particular pixel are projected at a refresh rate frequency of at least 30 hertz and more preferably between 60 hertz and 120 hertz. By generating a light beam from an RGB light source the projected animated image can be a color image. In preferred embodiments of the method a raster pattern is employed to project the image. When the micromechanical system projector employs a different type of image generator, such as an LCoS the method comprises manipulating the electric fields acting on the LCD pixel array to effect light absorption and non-absorption so that a light source received onto the LCD pixel array can be dynamically transformed in light intensity and color to produce still or animated images.

A preferred method uses light from the projected image to illuminate the ground next to a vehicle for assisting with passenger entry and exit, loading the vehicle, for changing a wheel, for helping the vehicle owner to locate the vehicle, or to alert others that the vehicle occupants require assistance. In another embodiment the method uses the light to provide illumination inside the vehicle, or to show information to the vehicle occupants. In yet another embodiment, the method can use the light from the automotive animated image projector to display decorative designs, information or advertising on an outside surface of the vehicle. For example, the information displayed on the outside of the vehicle could be a number or symbol that helps a person to find a rental car in a parking lot.

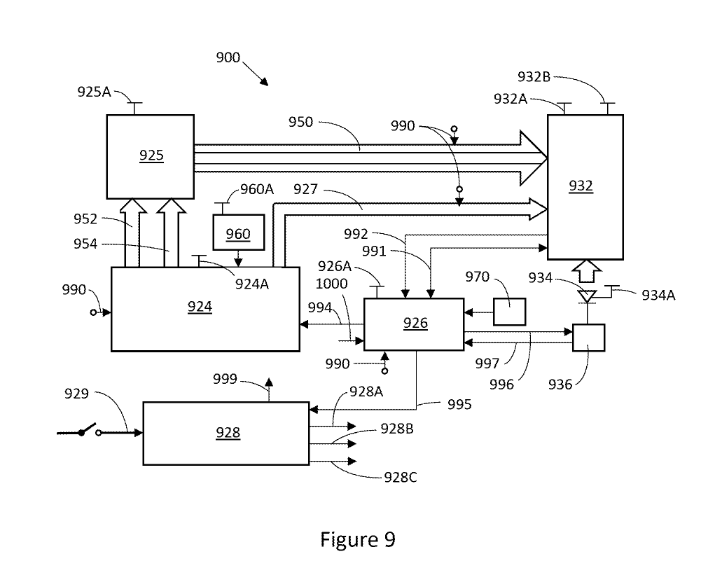

Reference is now made to FIG. 9, which is a schematic of automotive animated image projector 900, which is an alternative embodiment of the projector apparatus. In this embodiment, the animated images are still generated by a projector apparatus that comprises a light source, shown as LED 934 and LED drive transistor circuit 936, a microelectromechanical system projector, such as LCoS electro-mechanical imaging device 932, a computer system comprising micro controller unit (“MCU”) 926 and memory control engine 924, and transmission links for controlling the light source and the microelectromechanical system projector. Video control bus 927, being the transmission link between memory control engine 924 and LCoS 932, is an example of one of the transmission links.

An advantage of this embodiment is that it can be less expensive to manufacture because instead of using a more expensive multi-purpose high performance media processor, single purpose memory control engine 924 is substituted to generate predetermined sequential memory addresses in step with memory control signals and LCoS control signals. Memory control engine 924 is a programmable logic device, which by way of example, can be a complex programmable logic device (“CPLD”) or a field-programmable gate array (“FPGA”), or an ASIC. Memory control engine 924 is powered from power management system 928, which supplies power via regulated logic voltage rail 928A with power supplied to memory control engine 924 through power input 924A. Power from regulated logic voltage rail 928A is also delivered to power input 960A to power clock 960 (oscillator) which is illustrated in this embodiment as an external component. Clock 960 provides cyclic timing to memory control engine 924. Memory control unit 924 is activated when MCU 926 is not asserting a reset. In one embodiment, by way of example, memory control unit 924 can comprise state machine 1 in logic fabric generates linear address range for video data (67,108,864 unique sequential address values from 0 to 67,108,863 expressed on a 26 bit wide parallel memory address bus); state machine 2 in logic fabric generates memory control signals synchronized to linear address generation; and state machine 3 in logic fabric generates LCoS control signals synchronized to video data. Memory control engine 924 communicates with memory 925 via memory address bus 952 and memory control bus 954. In this embodiment of the projector system, MCU 926 controls the reset and run mode to start and stop memory control engine 924 through control line 994, and monitors and controls LCoS management functions via a 2-wire serial connection, comprising asynchronous low speed serial data link 991, which provides, among other things, image configuration control, image Gamma control and display COM voltage range control, and data line 992 through which the display's COM voltage monitor signal is returned to MCU 926. That is, MCU 926 can monitor the internal COM voltage for LCoS 932 and make adjustments thereto via the 2-wire serial connection. Through control line 996 and feedback line 997 connecting MCU 926 and LED drive transistor circuit 936, MCU 926 monitors, controls and regulates LED current and calibrates LED light output. MCU 926 monitors system temperature by receiving data from temperature sensor 970. If temperature sensor 970 measures a temperature that indicates that there is a danger of exceeding the specified temperature limits for any of the system components, electrical current to the LED light source can be reduced or suspended to keep any components from being overheated. In this embodiment, the LED light source comprises LED 934 and LED driver transistor circuit 936. Power is delivered to power input 934A from power management system 928 via LED power supply 928B. LED 934 produces a light beam when current is driven through it. LED drive transistor circuit 936 can comprise a pulse width modulation (“PWM”) integrator, and current sensor resistor. MCU 926 drives a variable duty cycle PWM signal into a RC integrator network which converts the PWM to a variable DC voltage as a function of the duty cycle. LED current develops voltage across the current sensor resistor. MCU 926 can monitor the LED current voltage and make continuous adjustments to account for changes in LED forward voltage. Power is delivered to MCU 926 through power input 926A, which receives power from power management system 928 via regulated logic voltage rail 928A. MCU 926 controls LCoS power supply 928C and LED power supply 928B through control line 995. After the video image has been played, MCU 926 turns off LCoS power supply 928C and LED power supply 928B. MCU 926 can also help to manage power consumption, for example when a vehicle battery voltage has an abnormal condition (when the voltage outside the normal operating range). Data lines 999 and 1000 represent a vehicle battery monitoring link between power management system 928 and MCU 026. For example, when a low battery voltage condition is detected, MCU 926 can prevent automotive animated image projector 900 from being activated, or it can be activated in a low power consumption mode that has a reduced brightness or a shorter animation sequence, or light without animation.

The automotive industry is very competitive and reducing manufacturing costs can enable lower retail prices for finished products, which can result in an advantage in the marketplace. Unlike other embodiments which can employ a more general-purpose video display system, which can project many different video image sequences that are saved into memory or uploaded later, memory control engine 924 can have a fixed lockstep mode that produces the same animated image sequence every time. For example, twenty seconds of video with a QVGA or WQVGA graphics display resolution at 30 frames per second can provide the lighting effect that is desired for some automotive applications, such as a vehicle puddle lamp, where this embodiment can be employed to project the same animated imagery onto the ground each time the car door is unlocked or opened. The unlocking or opening of the car door can operate a switch associated with power input 929 as a simple way of controlling when power is sent to power management system 928 to activate automotive animated image projector 900. Power management system 928 produces the voltages needed by each component of the automotive animated image projector system.

Memory 925 can be an electronic solid-state non-volatile computer storage medium such as flash memory with the video data stored onto it during the manufacturing process. The capacity of memory 925 can be selected according to the length of the animated video image, the resolution, whether or not the image is projected is in color, and the number of frames per second. For example, for a twenty second animated video run at 30 frames per second, for 16 bits per pixel (5 red bits, 6 green bits and 5 blue bits), with a resolution of 320×240 (76,800 pixels) memory storage capacity of 737,280,000 bits is required. With industry standard memory sizes this amount of data can be stored on a 1 Gbit×16 NOR FLASH or alternatively 2×512×8 Mbit NOR FLASH. These memory specifications are just examples, and other memory technologies and configurations can be substituted, such as NAND Flash, One-Time Programmable Non-Volatile Memory (“OTP NVM”) or Serial Peripheral Interface (“SPI”) Flash Memory. The excess memory capacity could be employed to store up to 29 seconds of animated color video imaging data. With some applications, the video imaging data can be saved onto memory 925 during the manufacturing process, and the saved video image is the permanent animated video image displayed for a specific application. Power is delivered to memory 925 from regulated logic voltage rail 928A through power input 925A.

LCoS 932 receives video data from memory 925 via video data bus 950. Video data bus 950 is shown with divisions to represent three data streams for generating a color image, for example with one data stream for 5 bits of red data, a second data stream for 6 bits of green data, and a third data stream for 5 bits of blue data. LCoS 932 also receives control signals from memory control engine 924 via video control bus 927. Memory control engine 924 ensures synchronization between the data streams and the control signals. Power management system 928 provides two voltages to LCoS 932, one from regulated logic voltage rail 928A to power input 932A for logic operation and another voltage from LCoS power supply 928C to power input 932B for optical operation.

Test points 990 are provided for memory control engine 924 and MCE 926. Test points 990 can be used to put memory control engine 924 into a test mode for rapid production testing where special bit patterns and/or special images, for example, video test patterns can be generated. During manufacturing, test points can be used to prove successful assembly by activating special behaviors, such as video test patterns that allow automated video image testing.

Accordingly, for applications where reducing cost is more important than providing functional flexibility and higher performance features, automotive animated image projector 900 can deliver lighting with animated images at a reduced price point.

While the illustrated embodiments show particular examples, various modifications and alterations can be made to the examples within the scope of the claims and aspects of the different examples can be combined in different ways to achieve further examples. Accordingly, the scope of the claims is to be understood from the entirety of the present disclosure in view of, but not limited to the embodiments illustrated and described herein. That is, with the benefit of the teachings of this disclosure it will be apparent that various modifications and variations can be made without departing from the spirit or scope of the claims.

What is claimed is:

1. A lighting system comprising:
a light source for integrating with an automotive vehicle and for emitting a light beam;
a projector aligned to receive said light beam and project an animated image onto one or more pre-determined target surfaces;
a processor programmed to control said light source and said projector to produce said animated image; and
one or more transmission links for communicating at least one signal between said processor, said light source, and said projector, the at least one signal containing information for causing the animated image to be projected.

2. The lighting system of claim 1, wherein said light source is a laser.

3. The lighting system of claim 2, wherein said laser comprises red/green/blue (RGB) laser diodes.

4. The lighting system of claim 1, wherein said projector is a microelectromechanical projector comprising a 2-dimensional laser scanning device.

5. The lighting system of claim 4, wherein said 2-dimensional laser scanning device comprises a scanning mirror connected to flexures associated with two different axes and a mechanism for rotating said scanning mirror around said two different axes.

6. The lighting system of claim 4, wherein said animated image is generated by light projected in a raster pattern.

7. The lighting system of claim 1, wherein said projector comprises a scanned 1-dimensional array.

8. The lighting system of claim 1, wherein said projector comprises a digital micro-mirror device.

9. The lighting system of claim 1, wherein said processor comprises a microelectromechanical ASIC programed to control said projector.

10. The lighting system of claim 9, wherein said processor further comprises a video ASIC programed to control said light source and to give commands to said microelectromechanical ASIC.

11. The lighting system of claim 1, wherein said processor comprises a memory device for storing image data.

12. The lighting system of claim 1, wherein said processor is further programmed to process image data received from an external source.

13. The lighting system of claim 1, wherein said one or more pre-determined target surfaces is/are one of an inner surface of the automotive vehicle, an outer surface of the automotive vehicle, and a surface external of the automotive vehicle.

14. The lighting system of claim 13, further comprising an exterior mirror device of the automotive vehicle, wherein said projector and said light source are integrated into a component of the mirror device.

15. The lighting system of claim 1, wherein said projector comprises an LCoS with an LCD pixel array.

16. The lighting system of claim 15, wherein said LCD pixel array is one of a transmissive LCD pixel array or a reflective LCD pixel array.

17. The lighting system of claim 1, further comprising a housing within which said projector and said processor and optionally said light source are disposed, said housing defining an interior volume less than 85 cubic centimeters, and more preferably less than 60 cubic centimeters.

18. The lighting system of claim 17, wherein said housing comprises a plastic material with a thermal conductivity greater than 0.5 W/(m·K), and more preferably between 5 and 15 W/(m·K).

19. The lighting system of claim 17, wherein said housing is sealed by low pressure overmolding.

20. The lighting system of claim 1, wherein said processor comprises a memory control engine that generates sequential memory addresses in step with memory control signals and projector control signals.

21. The lighting system of claim 20, wherein said memory control engine is a programmable logic device selected from the group consisting of CPLD, FPGA and ASIC.

22. A method of illuminating a surface comprising:
mounting a microelectromechanical projector on an automotive vehicle;
generating a light beam;
directing said light beam onto the microelectromechanical projector;
manipulating said light beam by dynamically controlling said microelectromechanical projector to generate animated images that are projected onto one or more pre-determined target surfaces.

23. The method of claim 22, wherein said microelectromechanical projector comprises a MEMS micro-mirror, and wherein said method further comprises dynamically controlling an orientation of said MEMS micro-mirror to illuminate individual pixels in the animated images.

24. The method of claim 22, wherein said generated light beam is generated from an RGB light source, and wherein said method further comprises controlling said light source to control the color of the light beam.

25. The method of claim 23, further comprising projecting said animated images using a raster pattern.

26. The method of claim 22, wherein said microelectromechanical projector comprises an LCoS LCD pixel array, and wherein said method further comprises dynamically controlling one or more electrical fields applied to said LCoS LCD pixel array to generate the animated images.

27. The method of claim 22, wherein said one or more pre-determined target surfaces is/are a surface exterior to the automotive vehicle, and wherein said method further comprising using said animated image to illuminate said surface exterior to the automotive vehicle.

28. The method of claim 22, wherein said one or more pre-determined target surfaces is/are an interior surface of said automotive vehicle, and wherein said method further comprises using said animated image to illuminate said interior surface.

29. The method of claim 28, wherein said animated images are video images captured by an onboard camera.

30. The method of claim 22, wherein said one or more pre-determined target surfaces is/are an external surface of said automotive vehicle, and wherein said method further comprises using said animated image to illuminate said external surface.

31. The method of claim 22, further comprising selecting said animated image from a plurality of available images, based upon a current state of the automotive vehicle or a change in the current state of the automotive vehicle.

32. The method of claim 31, wherein said current state or said change in the current state is one or an unlocked door of the automotive vehicle and a change from a locked to an unlocked state.
